(19) United States
(12) Patent Application Publication
(10) Pub. No.: US 2025/0148797 A1
(43) Pub. Date: May 8, 2025

(54) IMAGE PROCESSING APPARATUS, IMAGE PROCESSING METHOD, AND IMAGE PROCESSING SYSTEM

(71) Applicant: SONY SEMICONDUCTOR SOLUTIONS CORPORATION, KANAGAWA (JP)

(72) Inventor: SATOSHI NAKAYAMA, KANAGAWA (JP)

(21) Appl. No.: 18/726,184

(22) PCT Filed: Nov. 28, 2022
(86) PCT No.: PCT/JP2022/043653

§ 371 Date: Jul. 2, 2024

(30) Foreign Application Priority Data
Jan. 12, 2022 (JP) 2022-003001

(51) Int. Cl. G06V 20/56; G06T 7/70; G06V 10/25

(52) U.S. Cl. CPC G06V 20/56; G06T 7/70; G06V 10/25; G06V 2201/07

(57) ABSTRACT

To provide an image processing apparatus that causes an object recognition function and vehicle control following the object recognition function to correctly function even with a monocular camera. A signal processing apparatus according to an embodiment of the present technology includes an acquisition unit and a control unit. The acquisition unit acquires a captured image including a detection target and a reflector reflecting the detection target, the captured image being captured by an imaging unit. The control unit calculates information related to a position of the detection target with respect to the imaging unit on the basis of at least one of first image information that is image information of a first image region including the detection target in the captured image or second image information that is image information of a second image region including the reflector in the captured image.

### TECHNICAL FIELD

The present technology relates to an image processing apparatus mounted on, for example, a vehicle, an image processing method, and an image processing system.

### BACKGROUND ART

Conventionally, a camera apparatus mounted on a vehicle for visual recognition through a monitor apparatus installed in vicinity of a cockpit has been provided to improve convenience and safety of an automobile. As this type of camera, for example, Patent Literature 1 has disclosed a vehicle-mounted camera system that includes a vehicle-mounted camera with a lens and an image pickup element, a mirror that reflects an image on a lens surface and forms an image thereof on the image pickup element, a storage circuit that stores the image on the lens surface that is a reference, and an image processing unit that compares the image on the lens surface that is the reference with the image on the lens surface that is formed on the image pickup element and detects an object sticking to the lens or an abnormality of the lens surface.

### CITATION LIST

### Patent Literature

Patent Literature 1: Japanese Patent No. 6744575

### DISCLOSURE OF INVENTION

### Technical Problem

However, the vehicle-mounted camera system according to Patent Literature 1 is a monocular camera, and thus in a case where dirt such as rain drops and sludge has stuck to the lens, it is difficult to cause an object recognition function for a following vehicle and the like or vehicle control following the object recognition function to correctly function in a state in which dirt has stuck to the lens.

In view of the above-mentioned circumstances, it is an objective of the present technology to provide an image processing apparatus that causes an object recognition function and vehicle control following the object recognition function to correctly function even with a monocular camera.

### Solution to Problem

In order to accomplish the above-mentioned objective, an image processing apparatus according to an embodiment of the present technology includes an acquisition unit and a control unit.

The acquisition unit acquires a captured image including a detection target and a reflector reflecting the detection target, the captured image being captured by an imaging unit.

The control unit calculates information related to a position of the detection target with respect to the imaging unit on the basis of at least one of first image information that is image information of a first image region including the detection target in the captured image or second image information that is image information of a second image region including the reflector in the captured image.

In the image processing apparatus, the information related to the position of the detection target with respect to the imaging unit is calculated on the basis of at least one of the image information of the detection target or the image information of the reflector reflecting the detection target, which have been captured by the imaging unit. Accordingly, even a monocular camera can use the image information of the detection target reflected on the reflector, and thus an image processing apparatus that causes an object recognition function and vehicle control following the object recognition function to correctly function can be provided.

The control unit may extract a preset first particular region of the first image region and a second particular region of the second image region, the second particular region corresponding to a reflected image in the first particular region.

The first image information may be image information of a preset first particular region of the first image region, and the second image information may be image information of a second particular region of the second image region, the second particular region corresponding to a reflected image in the first particular region.

The information related to the position of the detection target may be a relative distance of the detection target with respect to the imaging unit.

The control unit may determine whether or not a first pixel region corresponding to a particular pattern preset is present in at least a part of the first image information and detect dirt on a light-receiving unit of the imaging unit on the basis of a result of the determination.

In a case where the control unit detects dirt on the light-receiving unit, the control unit may extract a second pixel region of the second image information and generates, on the basis of pixel information of the second pixel region, a display image in which the first pixel region is complemented with the pixel information of the second pixel region, the second pixel region corresponding to a reflected image in the first pixel region.

In a case where the control unit detects dirt on the light-receiving unit, the control unit may calculate the information related to the position of the detection target with respect to the imaging unit on the basis of the second image information.

An image processing method according to an embodiment of the present technology includes: acquiring a captured image including a detection target and a reflector reflecting the detection target, the captured image being captured by an imaging unit; and calculating information related to a position of the detection target with respect to the imaging unit on the basis of at least one of first image information that is image information of a first image region including the detection target in the captured image or second image information that is image information of a second image region including the reflector in the captured image.

An image processing system according to an embodiment of the present technology includes an imaging unit, a reflector, and an image processing apparatus.

The image processing apparatus includes an acquisition unit that acquires a captured image including a detection target and the reflector reflecting the detection target, which are imaged by the imaging unit, and a control unit that calculates information related to a position of the detection target with respect to the imaging unit on the basis of at least one of first image information that is image information of a first image region including the detection target in the captured image or second image information that is image information of a second image region including the reflector in the captured image.

The reflector may include a content display unit that displays preset content.

The control unit may cause the content displayed by the content display unit to be periodically displayed to blink for a non-exposure period of the imaging unit.

The reflector may be an optical element that causes detection target light of the detection target to be reflected to a light-receiving unit of the imaging unit and causes content light of the content display unit to pass through the optical element.

The imaging unit may be a vehicle-mounted camera that images at least a part of a periphery of a vehicle body, and the reflector may be provided below the imaging unit.

### BRIEF DESCRIPTION OF DRAWINGS

FIG. 1 A block diagram of an image processing system according to an embodiment of the present technology.

FIG. 2 A general view of a camera unit.

FIG. 3 Views of an automobile including the image processing system, in which (A) is a perspective view of an automobile backside and (B) is a side view of the automobile backside.

FIG. 4 A view showing optical paths of target object light.

FIG. 5 Captured images of the automobile backside where no dirt has stuck to the camera, in which (A) is a general view of the automobile backside, (B) is a view where a detection target of the automobile backside has been imaged without a mirror, and (C) is a view including the mirror reflecting the automobile backside.

FIG. 6 Captured images of the automobile backside where dirt has stuck to the camera, in which (A) is a general view of the automobile backside, (B) is a view where the detection target of the automobile backside has been imaged without using the mirror, and (C) is a view including the mirror reflecting the automobile backside.

FIG. 7 Views describing complement of a first image region G1, in which (A) is a view of the first image region G1 in which dirt D is detected, (B) is a view of a second pixel region C22 corresponding to a first pixel region which is a dirt portion of (A) of a second image region G2, and (C) is a view of a display image G3 in which pixel information of the second pixel region C22 is complemented.

FIG. 8 A flowchart showing distance measurement processing of an image processing apparatus.

FIG. 9 A flowchart showing complement processing of the image processing apparatus.

FIG. 10 A block diagram showing a configuration of an image processing system according to a second embodiment of the present technology.

FIG. 11 A view showing a configuration of an image processing system according to a second embodiment of the present technology.

FIG. 12 A diagram showing a shutter timing and a light emission timing.

FIG. 13 A side view of a camera unit and a detection target.

### MODE(S) FOR CARRYING OUT THE INVENTION

Hereinafter, embodiments according to the present technology will be described with reference to the drawings.

### First Embodiment

### [Image Processing System]

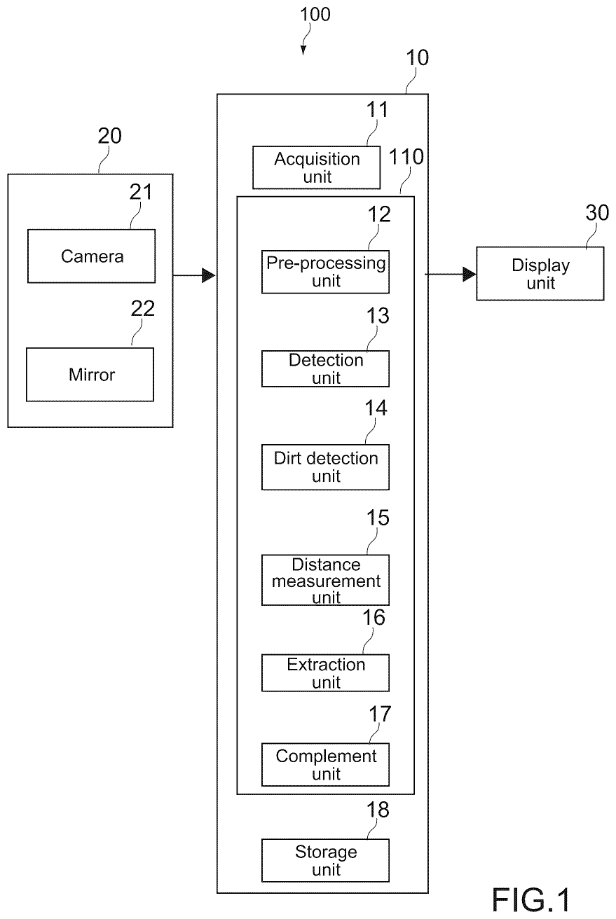

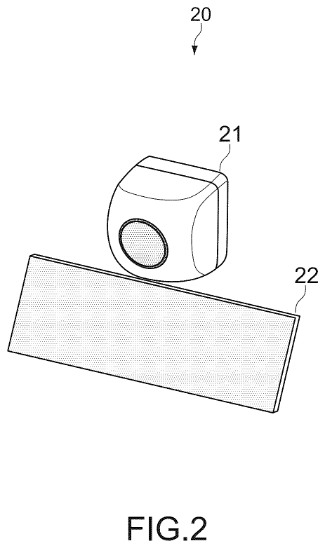

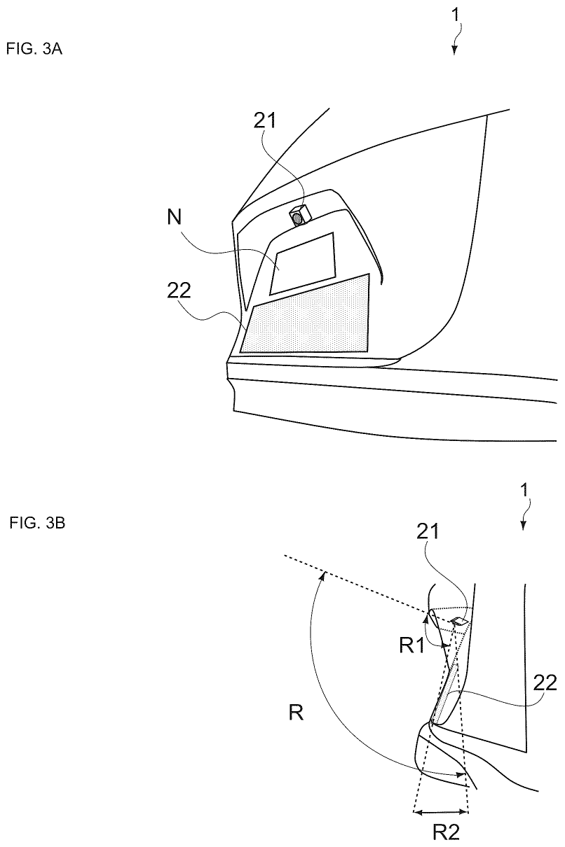

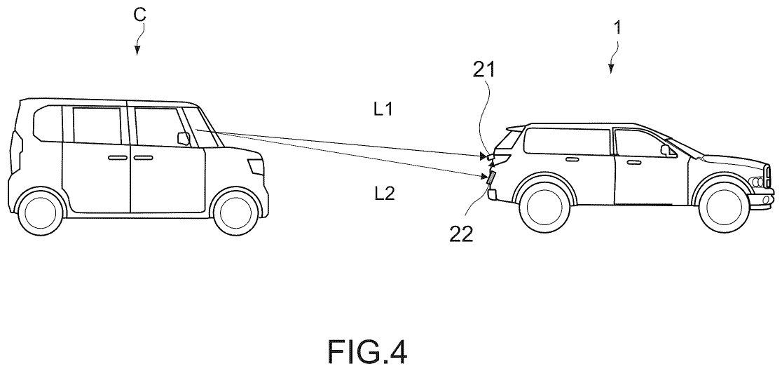

FIG. 1 is a block diagram showing a configuration of an image processing system 100 according to an embodiment of the present technology. FIG. 2 is a general view of a camera unit 20. FIG. 3 is views of an automobile 1 including the image processing system 100, in which (A) is a perspective view of an automobile backside and (B) is a side view of the automobile backside. Moreover, FIG. 4 is a view showing optical paths of target object light.

The image processing system according to the present embodiment is installed in a movable object including a watercraft, a flying object such as a drone, a vehicle, and the like. In the present embodiment, an image processing system according to the present embodiment will be described exemplifying the automobile as the movable object.

As shown in FIG. 1, the image processing system 100 mainly includes an image processing apparatus 10, the camera unit 20, and a display unit 30.

### (Image Processing Apparatus)

The image processing apparatus 10 controls respective units of the image processing system 100. The image processing apparatus 10 is configured to display a captured image of a backside of the automobile 1 by the camera unit 20, on the display unit 30 installed inside the automobile 1. The display unit 30 is, for example, a screen of a car navigation system. It should be noted that the image processing apparatus 10 will be described later in detail.

### (Camera Unit)

The camera unit 20 as shown in FIG. 2 includes a camera 21 serving as an imaging unit and a mirror 22 that is a reflector. As shown in (A) and (B) of FIG. 3, in the present embodiment, the camera unit 20 is a vehicle-mounted camera that images at least a part of the periphery of the automobile 1 and is also a rear-view camera that is installed in the backside of the automobile 1 and is capable of imaging the backside of the automobile 1.

A digital camera including an image sensor such as a complementary metal-oxide semiconductor (CMOS) sensor or a charge coupled device (CCD) sensor, for example, is used as the camera 21. Otherwise, for example, an infrared camera installing an infrared light such as an infrared LED may be used. It should be noted that a fisheye camera having a wide visual field may be used as the camera 21. Moreover, although the angle of view of the camera 21 is not particularly limited, it is favorable that the camera 21 has an angle of view to be capable of properly imaging a periphery behind the camera 21 (automobile 1) ranging from approximately several meters to several tens of meters.

In the present embodiment, as shown in FIGS. 2 and 3, the camera 21 is installed above a license plate N on the backside of the automobile 1. However, the present technology is not limited thereto, and the camera 21 may be installed under the license plate N. Moreover, the camera 21 may be, for example, a front-view camera that is arranged in front of the automobile 1 to be capable of imaging a front side of the automobile 1 or may be a side-view camera that is arranged in a wing mirror to be capable of imaging a lateral side of the automobile.

The mirror 22 is provided below the camera 21. In the present embodiment, the mirror 22 is positioned below the license plate N. The shape of the mirror 22 is a rectangular shape which is substantially left-right symmetric about a lens position of the camera 21. In the present embodiment, the mirror 22 regularly reflects target object light of a target object located on the backside of the automobile 1 and causes the target object light to enter a lens which is a light-receiving unit of the camera 21. The angle of installation of the mirror 22 is favorably set so that light regularly reflected on a target object such as a following vehicle located in a range of approximately several meters to several tens of meters from the camera 21 (automobile 1) enters the lens of the camera 21 as in the angle of view of the camera 21. Moreover, the angle of the mirror 22 only needs to be set so that no sunlight and the like reflected by the mirror 22 hit a user of the following vehicle.

As shown in (B) of FIG. 3, a region R shown by the broken line is an imaging range of the camera 21. A region R2 of the region R is a region of the imaging range of the camera 21, in which the vehicle body of the automobile 1 is imaged. A region R1 is a region of the imaging range of the camera 21, in which the vehicle body of the automobile 1 is not imaged. Moreover, in the present embodiment, as shown in (B) of FIG. 3, the mirror 22 is arranged at a position corresponding to the region R2.

In the present embodiment, the mirror 22 is attached to the automobile 1 and is arranged apart from the camera 21, though not limited thereto. An integral object directly attached to the periphery of the camera 21 may be employed. The positional relationship between the camera 21 and the mirror 22 can be set as appropriate.

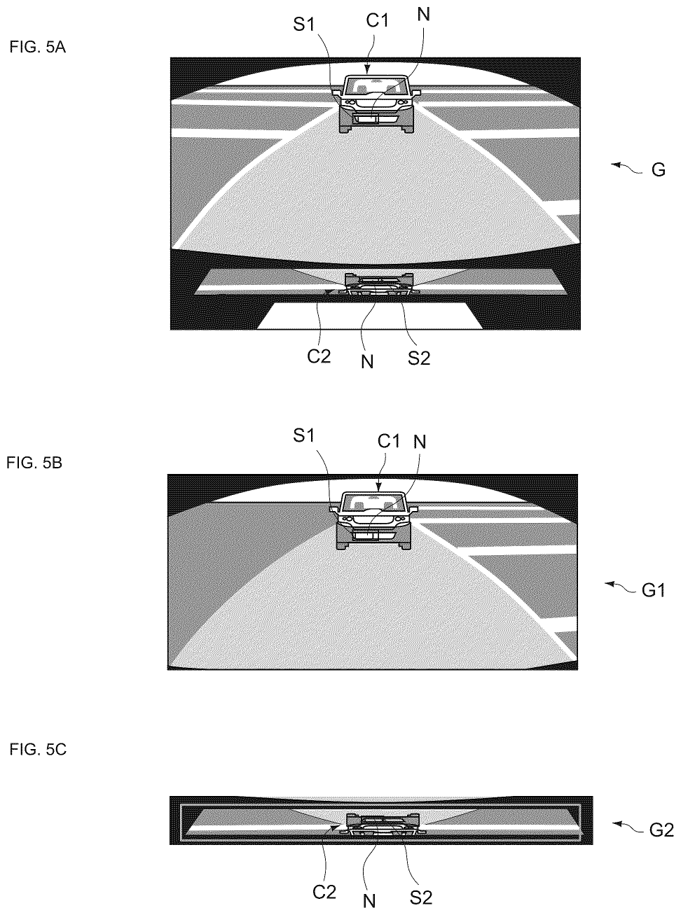

FIG. 5 shows a captured image of the automobile backside where no dirt has stuck to the camera 21, in which (A) is a general view of the automobile backside, (B) is a view where a detection target of the automobile backside has been imaged without using the mirror, and (C) is a view including the mirror reflecting the automobile backside. As shown in FIG. 5, a captured image G captured by the camera 21 includes a first image region G1 and a second image region G2.

As shown in FIG. 4 and (C) of FIG. 5, the second image region G2 is a region including the mirror 22 reflecting a detection target C. Moreover, the detection target C in the second image region G2 is imaged in such a manner that target object light of the detection target C is reflected on the mirror 22 (optical path L2 of the target object light) and the reflected light enters the lens of the camera 21.

The first image region G1 is a region including the detection target C. Moreover, the detection target C in the first image region G1 is imaged in such a manner that the target object light of the detection target C enters the lens of the camera 21 without using the mirror (optical path L1 of the target object light). Therefore, a detection target C2 displayed on the second image region G2 is an image inverted up and down with respect to a detection target C1 in the first image region G1 and distorted by the angle of installation of the mirror 22.

As shown in (A) to (C) of FIG. 5, the first image region G1 has an angle of view wider than an angle of view of the second image region G2. Moreover, a position of a second image G2 in the captured image G corresponds to the position where the mirror 22 is arranged.

Moreover, although the size of the mirror 22 can be set as appropriate, the mirror 22 has, for example, a size to be included in the angle of view in the captured image G as shown in FIG. 5.

### (Image Processing Apparatus)

The image processing apparatus 10 includes an acquisition unit 11, a control unit 110, and a storage unit 18 as functional blocks of the CPU and the control unit 110 includes a pre-processing unit 12, a detection unit 13, a dirt detection unit 14, a distance measurement unit 15, an extraction unit 16, a complement unit 17, and the storage unit 18 (see FIG. 1).

The acquisition unit 11 acquires the captured image G including the detection target C and the mirror 22 reflecting the detection target C, which has been captured by the camera 21, at a predetermined frame rate and stores the captured image G in the storage unit 18.

The pre-processing unit 12 extracts an image so that the captured image G acquired by the acquisition unit 11 can be processed by the detection unit 13 to be described later. In the present embodiment, as shown in (A) to (C) of FIG. 5, the pre-processing unit 12 extracts the first image region G1 including the detection target C1 from the acquired captured image G and the second image region G2 including the mirror 22 reflecting the detection target C2. The size of the image region of the first image region G1 or the second image region G2 extracted by the pre-processing unit 12 is not particularly limited, and can be set as appropriate in accordance with the angle of view of the camera 21 and the size of the mirror 22.

The detection unit 13 detects first image information which is image information of the first image region G1 and second image information which is image information of the second image region G2, which have been extracted by the pre-processing unit 12. The detection unit 13 includes, for example, a deep learning device, and determines whether or not a detection target is present in an input image while using a learning model stored in the storage unit 18 to be described later and, in a case where the detection target is present, detects type and position of the detection target for each detection target. In the present embodiment, the object set as the detection target object is the automobile, though not limited thereto as a matter of course. The object set as the detection target object may be a pedestrian or may be a utility pole, a wall, or the like.

Moreover, in a case where the detection target is a vehicle such as an automobile, the detection unit 13 may recognize a lane where the user's vehicle is travelling (e.g., recognize two white lines) or may recognize the vehicle in the lane as the detection target.

Furthermore, the detection unit 13 extracts a preset first particular region S1 of the first image region G1 and a second particular region S2 of the second image region G2, which corresponds to a reflected image in the first particular region S1 (see (A) of FIG. 5).

The first particular region S1 and the second particular region S2 are regions which are features of the detection target C and, in the present embodiment, are regions including the license plate N. In the present embodiment, the particular region is the license plate, though not limited thereto as a matter of course. The particular region may be a windshield.

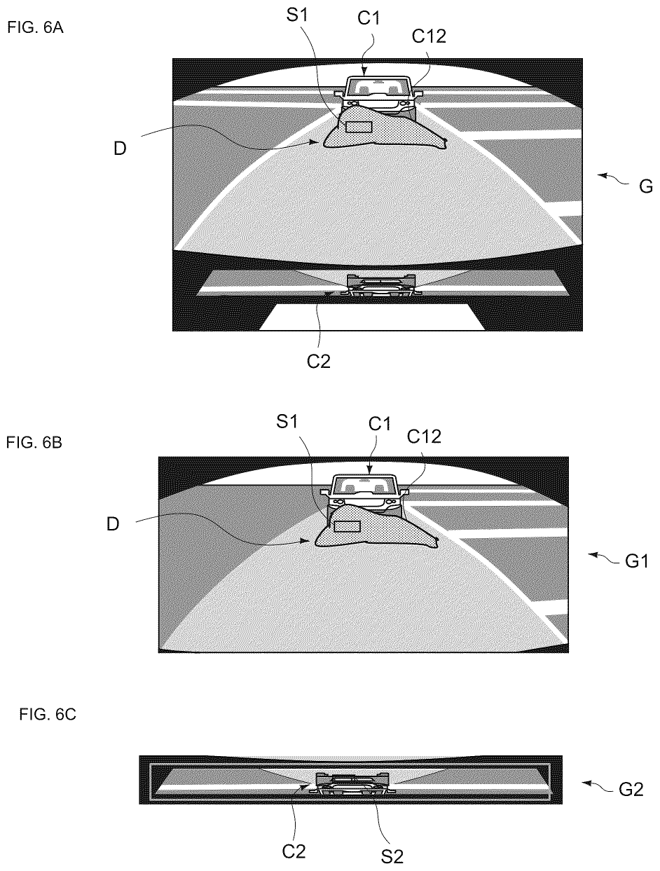

FIG. 6 shows a captured image of the automobile backside where dirt has stuck to the camera 21, in which (A) is a general view of the automobile backside, (B) is a view where a detection target of the automobile backside has been imaged without using the mirror, and (C) is a view including the detection target of the mirror reflecting the automobile backside.

On the basis of the first image information which is the image information of the first image region G1 extracted by the detection unit 13 and the second image information which is the image information of the second image region G2, the dirt detection unit 14 determines whether or not a first pixel region C12 corresponding to a particular pattern preset in the storage unit 18 is present and detects dirt on the lens of the camera 21 on the basis of a result of the determination.

Here, the first image information includes the detection target C1 in the first image region G1 and the preset first particular region S1 in the first image region G1. The second image information includes the detection target C2 in the second image region G2 and the preset second particular region S2 of the second image region G2.

Moreover, the first pixel region C12 corresponding to the particular pattern is, for example, a mud stain. The presence of the mud stain causes a partial pixel region to indicate pixel values of brown color specific to the mud stain, and it is a pixel region having the specific pixel values.

For example, as shown in (A) and (B) of FIG. 6, the dirt detection unit 14 determines dirt D overlapping the image region of the detection target C1 as the dirt on the lens of the camera 21. In the present embodiment, the dirt detection unit 14 includes the deep learning device and determines whether or not dirt is present in the captured image while using the learning model stored in the storage unit 18 and, in a case where the dirt is present, detects a position of the dirt. Moreover, the dirt is not limited to the mud stain, and the dirt may be water drops or the like. A method of detecting the dirt is not limited to the deep learning. For example, a method of acquiring difference images from a plurality of captured images captured in time series and determining, in a case where a change in pixel value between the difference images is a predetermined value or less, a region with the predetermined value or less as dirt may be employed.

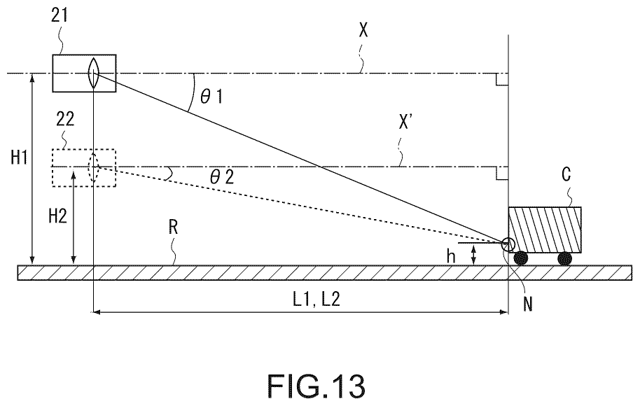

FIG. 13 is a side view of the camera unit 20 and the detection target C.

The distance measurement unit 15 calculates information related to positions of the camera 21 (automobile 1) and the detection target C (following vehicle). For example, in a case where no dirt D is present in the first particular region S1 of the first image region G1 and the second particular region S2 of the second image region G2 as shown in (A) to (C) of FIG. 5, the distance measurement unit 15 calculates, as shown in FIG. 4 and (A) to (C) of FIG. 5, information related to the position of the detection target C with respect to the camera 21 on the basis of the first image information (optical path L1) of the first image region G1 and the second image information (optical path L2) of the second image region (first distance measurement).

Moreover, in a case where the dirt D is detected in the first particular region S1 as shown in (A) to (C) of FIG. 6, the distance measurement unit 15 calculates the information related to the position of the detection target C with respect to the camera 21 by using the second particular region S2. The method of performing the distance measurement with the monocular camera is not particularly limited, and various methods can be employed. For example, as shown in FIGS. 6 and 13, the distance measurement unit 15 calculates a tilt angle θ1 of the first particular region S1 with respect to an optical axis X, which is based on the position (image height) of the first particular region S1 and image height properties of the camera 21, calculates a height h of one corner portion of, for example, four corners of the license plate N from a road R on the basis of the pixel information of the first image region G1, and calculates the information related to the position of the detection target C with respect to the camera 21 on the basis of a distance H1 between the camera 21 and the road R (second distance measurement). Here, the first particular region S1 is associated with the camera 21 and the license plate N corresponds to the first particular region S1.

A calculation method for the above-mentioned first distance measurement will be described. As to the first distance measurement, the distance measurement unit 15 calculates information related to the position of the detection target C with respect to the mirror 22 on the basis of the above-mentioned second distance measurement and distance measurement information based on the second image information captured through the mirror 22.

As to such distance measurement information, the distance measurement unit 15 calculates the information related to the position of the detection target C with respect to the mirror 22. Here, on the basis of the second image information, the distance measurement unit 15 calculates the distance measurement information as one obtained by imaging the second image region G2 through the mirror 22. That is, as shown in FIGS. 6 and 13, the distance measurement unit 15 calculates a tilt angle θ2 with respect to the optical axis X′ (parallel to the optical axis X) of the second particular region S2 corresponding to the mirror 22 based on the position (image height) of the second particular region S2 and the image height properties of the camera 21, calculates the height h from the road R with respect to one corner portion of, for example, four corners of the license plate N corresponding to the second particular region S2 on the basis of pixel information of the second image region G2, and calculates the information related to the position of the detection target C with respect to the mirror 22 on the basis of a distance H2 between the mirror 22 and the road R.

Moreover, in a case where no dirt has been detected in the first particular region S1 and dirt has been detected in the second particular region S2 (this case is not shown in the figure), the distance measurement unit 15 calculates the information related to the position of the detection target C with respect to the camera 21 by using the first particular region S1 (second distance measurement).

A relative distance L1 of the camera 21 with respect to the detection target C measured by the above-mentioned second distance measurement is calculated as follows.

$$L 1 = ( H 1 - h ) * tan θ 1$$

Moreover, a relative distance L2 of the detection target C with respect to the mirror 22 based on the distance measurement information based on the second image information is calculated as follows.

$$L 2 = ( H 2 - h ) * tan θ 2$$

The distance measurement unit 15 calculates the information related to the position of the detection target C with respect to the camera 21 on the basis of the relative distances L1 and L2. For example, the distance measurement unit 15 may calculate a numeric value of the distance close to the camera 21 out of the calculated relative distances L1 and L2 as a relative distance of the detection target C with respect to the camera 21 or may calculate an average of the relative distances L1 and L2 as a relative distance of the detection target C with respect to the camera 21.

Information regarding the above-mentioned position is, for example, a relative distance, though not limited thereto. For example, it may be a relative speed using captured images captured in time series.

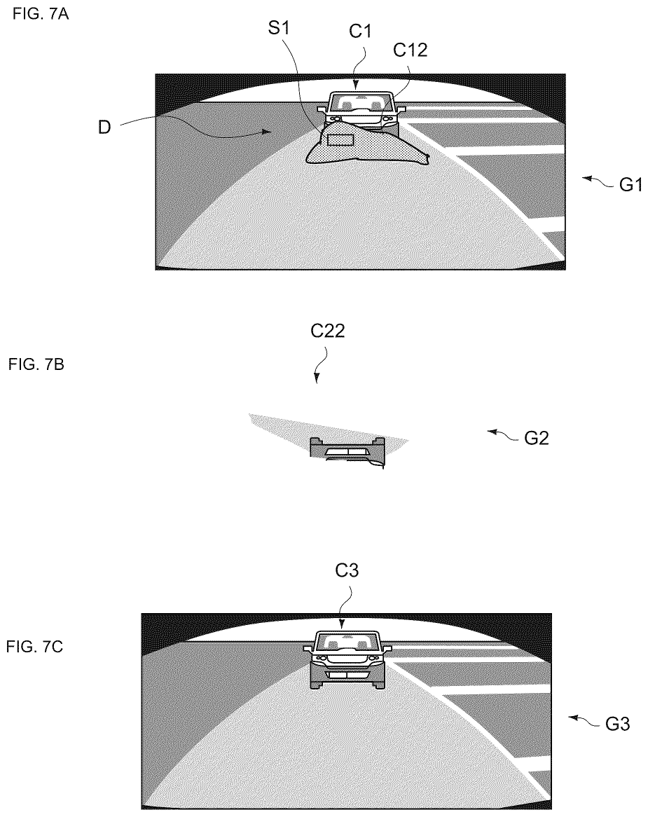

FIG. 7 is a diagram describing complement of the first image region G1, in which (A) is a view of the first image region G1 in which the dirt D has been detected, (B) is a view the second pixel region C22 corresponding to the first pixel region C12 which is the dirt portion of (A) out of the second image region G2, and (C) is a diagram of the display image G3 in which pixel information of the second pixel region C22 is complemented.

As shown in (A) and (B) of FIG. 7, in a case where the extraction unit 16 has detected the dirt D on the lens of the camera 21, the extraction unit 16 extracts the second pixel region C22 corresponding to a reflected image in the first pixel region C12.

Here, as shown in FIGS. 5 and 6, the first image region G1 and the second image region G2 imaged by the camera 21 are different from each other in how to look due to a difference of the optical axis. Therefore, the extraction unit 16 needs to perform processing of converting the optical axis of the camera 21 in order to extract the second pixel region C22. The method for converting the optical axis of the camera 21 is not particularly limited, and various methods can be employed. For example, by projecting the second image information onto a plane perpendicular to the optical path L1, an image with the viewpoint converted can be generated. Accordingly, the extraction unit 16 is capable of extracting the second pixel region C22 corresponding to the reflected image in the first pixel region C12.

As shown in (A) of FIG. 7, in a case where the dirt D is present on the detection target C1 in the first image region G1, the captured image G including the dirt D is displayed on the display unit 30 in this case, so it is difficult for the user to sense a distance from the detection target C. In view of this, in a case where the dirt D has been detected on the detection target C1 in the first image region G1, the complement unit 17 generates the display image G3 in which the first pixel region C12 is complemented with the pixel information of the second pixel region C22 obtained by the extraction unit 16 extracting the pixel information of the first pixel region C12 corresponding to the position of the dirt D.

In the present embodiment, as shown in (A) to (C) of FIG. 7, the extraction unit 16 extracts the second pixel region C22 in the second image region G2 and the complement unit 17 relaces the pixel information of the first pixel region C12 by the pixel information of the second pixel region C22. That is, in the present embodiment, the first pixel region C12 has a pixel value specific to, for example, a mud stain. Processing of replacing the pixel value specific to the mud stain by the pixel value of the second pixel region C22 is performed. Then, the display image G3 including a complement image region C3 in which the first pixel region C12 is complemented is generated.

In the present embodiment, the first pixel region C12 complemented by the complement unit 17 is present in a region overlapping the detection target C1, though not limited thereto. For example, even if the first pixel region C12 has been detected only in a road portion, the complement processing is performed. Accordingly, owing to the presence of dirt in the road portion between the automobile 1 and the detection target C, difficulties for the user to sense a distance between both can be reduced.

The storage unit 18 is constituted by a storage apparatus such as a hard disk or a semiconductor memory. The storage unit 18 stores programs and arithmetic operation parameters for causing the image processing apparatus 10 to execute the above-mentioned various functions and a learning model referred to for object detection processing in the detection unit 13 and dirt detection processing in the dirt detection unit 14. The storage unit 18 does not need to be built in the image processing apparatus 10. The storage unit 18 may be a storage apparatus separate from the image processing apparatus 10 or may be a cloud server or the like connectable to a control apparatus 10 via a network.

A model for the learning model according to the present embodiment is an object such as a person or an automobile in the first image region G1 captured without using the mirror 22, for example, and is an object in a state inverted up and down as compared to the first image region G1 and distorted by the angle of installation of the mirror 22 in the second image region G2 including the detection target reflected on the mirror 22.

Here, as described above, the dirt used in the present embodiment is dirt sticking to the lens of the camera 21. For example, the dirt in the first image region G1 refers to the dirt on the lens of the camera 21 corresponding to the first image region G1.

### [Processing Procedure]

### (Distance Measurement Flow)

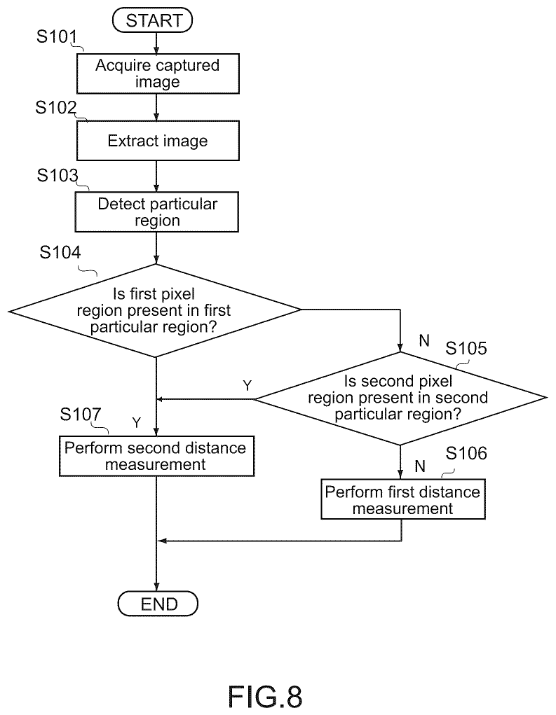

Subsequently, a procedure of performing the distance measurement of the image processing apparatus 10 configured in the above-mentioned manner will be described. FIG. 8 is a flowchart showing an example of a procedure the distance measurement processing executed by the image processing apparatus 10.

The acquisition unit 11 acquires a captured image of the camera 21 (Step 101). The captured image of the camera 21 is the captured image G including the first image region G1 including the detection target C1 and the second image region G2 including the detection target C2 reflected on the mirror 22, for example, as shown in (A) of FIG. 5 and (A) of FIG. 6.

Subsequently, the pre-processing unit 12 extracts the first image region G1 and the second image region G2 from the captured image G as shown in (A) of FIG. 5 and (A) of FIG. 6 (Step 102).

Subsequently, the detection unit 13 executes detection processing for the first particular region S1 and the second particular region S2 from each of the first image region G1 and the second image region G2 (Step 103). As to the detection processing for the particular region, the detection unit 13 detects whether or not the detection target is present in the captured image (the first image region G1 and the second image region G2) and detects, if an object is present, its type and position and extracts a particular region preset for each type of detection target.

Subsequently, the detection unit 13 detects whether or not the first pixel region C12 is present in the first particular region S1 (Step 104). In view of this, in a case where no first pixel region C12 is detected in the first particular region S1, the processing proceeds to Step 105. In the present embodiment, as shown in FIG. 6, the detection unit 13 detects whether or not the dirt D is present in the image region of the license plate N.

In Step 105, the dirt detection unit 14 detects whether or not the second pixel region C22 is present in the second particular region S2. In a case where no dirt has been detected also in the second particular region S2, a distance of the detection target C with respect to the camera 21 (automobile 1) is measured on the basis of the above-mentioned first distance measurement (Step 106).

In a case where the first pixel region C12 has been detected in the first particular region S1 or in a case where the second pixel region C22 has been detected in the second particular region S2, a distance between the camera 21 (automobile 1) and the detection target C is measured on the basis of the second distance measurement (Step 107).

After a distance of the detection target to the camera 21 is measured on the basis of the first distance measurement or the second distance measurement, the measurement result is displayed on the display unit 30. This flowchart may be performed in a case of measuring a distance to the following vehicle at the time of backward movement of the automobile 1 for example. The present technology is not limited thereto, and the flowchart may be constantly performed. As a matter of course, the present technology is not limited to the display on the display unit 30, and the measurement result may be transmitted to the user through the loudspeaker. Moreover, the present technology is not limited to the purpose for outputting it to the user, and for example, it may be used as information for controlling the vehicle-to-vehicle distance of the automated driving system.

### (Complement Flow)

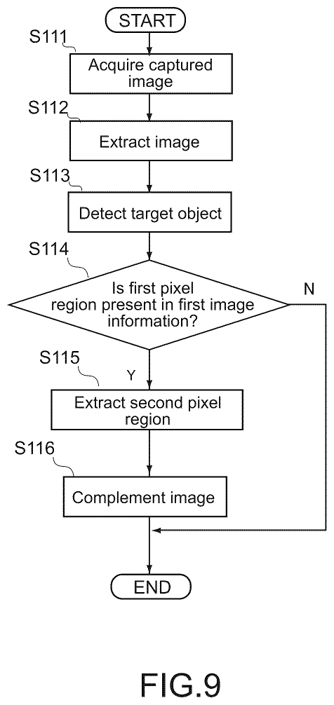

Subsequently, a procedure of performing the above-mentioned complement of the image processing apparatus 10 will be described. FIG. 9 is a flowchart showing an example of the procedure of the complement processing executed in the image processing apparatus 10.

In Steps 111 to 113, processing similar to Steps 101 to 103 in the above-mentioned distance measurement flow is performed.

In Step 114, the dirt detection unit 14 determines whether or not the first pixel region C12 corresponding to a particular pattern set in advance is present in at least a part of the first image information which is the image information of the first image region G1. In a case where the first pixel region C12 is present, the processing proceeds to Step 115.

In Step 115, as shown in (B) of FIG. 7, the extraction unit 16 extracts the second pixel region C22 of the second image information corresponding to the reflected image in the first pixel region C12.

Subsequently, the complement unit 17 generates the display image G3 in which the first pixel region C12 is complemented with the pixel information of the second pixel region C22 on the basis of the pixel information of the second pixel region C22 as shown in (C) of FIG. 7 (Step 116).

The complemented display image G3 is sent to the display unit 30 and is provided to the user. This flowchart may be performed in a case of measuring a distance to the following vehicle at the time of backward movement of the automobile 1 for example. The present technology is not limited thereto, and the flowchart may be constantly performed.

In the present embodiment, since the use of the image captured through the mirror 22 enables even a monocular camera to measure a distance, the distance measurement performance can be improved. Moreover, providing the mirror 22 below the imaging region of the camera 21 enables the efficient use of the imaging region of the camera 21. In particular, arranging the mirror 22 at a position in the imaging region of the camera 21 in which the vehicle body of the automobile 1 is imaged enables the imaging region of the camera 21 to be used efficiently.

Accordingly, since even the monocular camera can accurately recognize a vehicle-to-vehicle distance to the following vehicle at the time of backward movement of the automobile, it is possible not only to transmit the vehicle-to-vehicle distance to the following vehicle to the user, but also to use it for an automatic braking system in for example an automated driving system. Moreover, in a case where the vehicle-to-vehicle distance to the following vehicle is continuously very short during the forward movement, for example, determining that the following vehicle is tailgating, the police may be notified of it.

Moreover, even if dirt such as water drops and mud has stuck to the lens portion of the camera 21, it is difficult to complement the dirt with the monocular camera, and the user is provided with an image in which the dirt has stuck. Therefore, it has been difficult for the user to recognize a following vehicle and a distance to the following vehicle. In view of this, since in the present embodiment, it is possible to complement a portion in the first image region G1 in which dirt has been detected by using the second pixel region C22 of the second image region G2 including the detection target reflected on the mirror 22, the user can recognize a following vehicle and a distance to the following vehicle.

That is, by using the image information of the detection target reflected on the mirror 22, it is possible to cause an object recognition function and vehicle control following the object recognition function to correctly function even with the monocular camera.

### Second Embodiment

Subsequently, a second embodiment of the present technology will be described. Hereinafter, configurations different from those of the first embodiment will be mainly described, configurations similar to the first embodiment will be denoted by similar reference signs, and descriptions thereof will be omitted or simplified.

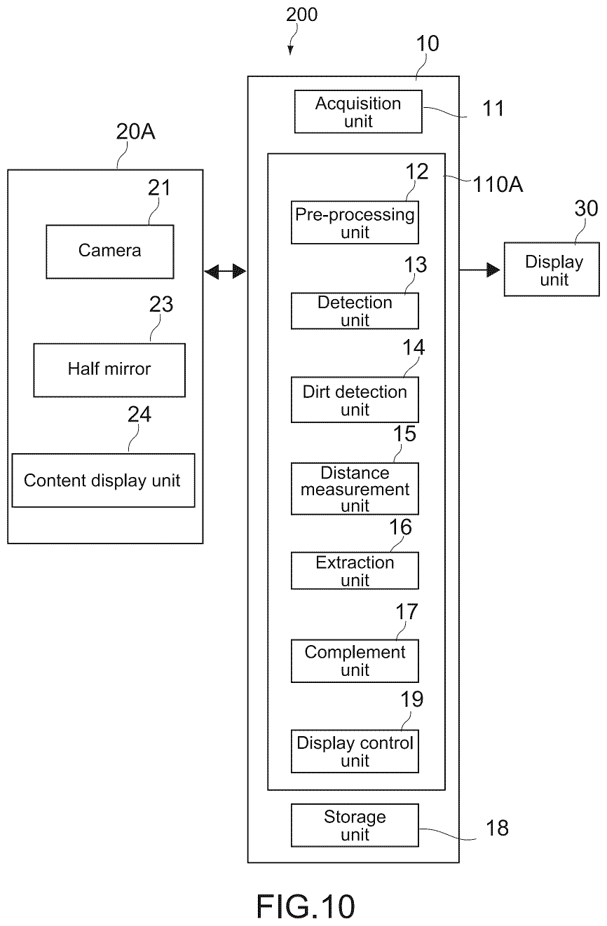

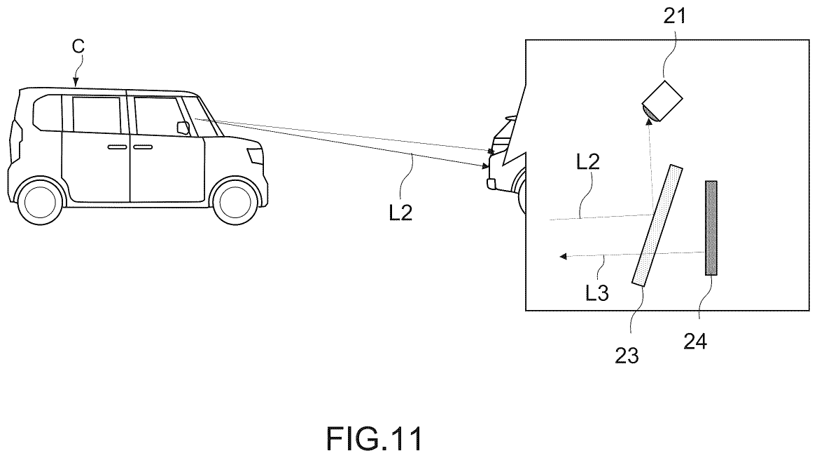

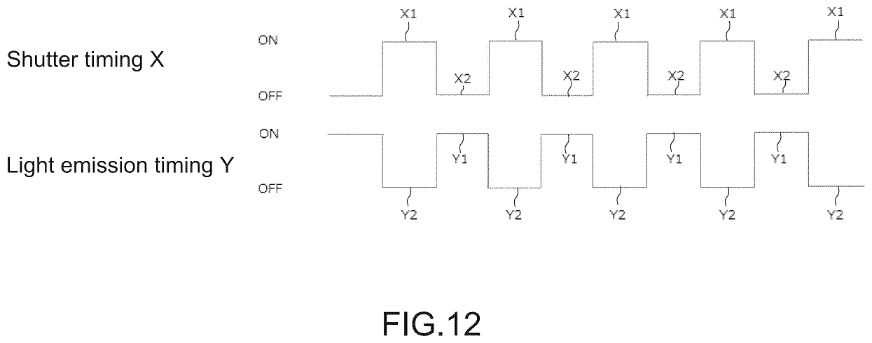

FIG. 10 is a block diagram showing a configuration of an image processing system 200 according to the second embodiment of the present technology. FIG. 11 is a diagram showing a configuration of the image processing system 200. Moreover, FIG. 12 is a diagram showing a shutter timing X and a light emission timing Y.

A camera unit 20A according to the present embodiment is different from that of the first embodiment in that the mirror 22 is installed in place of a half mirror 23 and a content display unit 24 is mounted on the vehicle side of the half mirror 23. Moreover, it is different from the first embodiment also in that a control unit 110A includes a display control unit 19 that causes content displayed by the content display unit 24 to be periodically displayed to blink for a non-exposure period of the camera 21. The content display unit 24 is typically an LED display, though not limited thereto. Any type of display such as a liquid-crystal display or an organic EL display can be employed.

As shown in FIG. 11, the half mirror 23 is an optical element having one surface that reflects detection target light L2 coming from the detection target C to the lens of the camera 21 and the other surface that allows content light L3 from the content display unit 24 to pass toward the backside of the automobile 1.

In the present embodiment, the content display unit 24 is a monitor for displaying the preset content to the automobile backside and the content refers to, for example, a still image, a moving image, color information, or the text information. Accordingly, it is configured to be capable of displaying a message and the like to the following vehicle, and thus it is possible to warn the following vehicle, for example, saying “driving back.”

Moreover, as shown in FIG. 12, the shutter timing X of the camera 21 includes an exposure period X1 and a non-exposure period X2 and the light emission timing Y includes a light emission period Y1 and a non-light emission period Y2. During the exposure period X1 of the camera 21, the content display unit 24 is the non-light emission period Y2. During the non-exposure period X2 of the camera 21, the content display unit 24 is the light emission period Y1. The frame rate when the camera 21 images the detection target C can be arbitrarily set, for example, to 30 fps.

As described above, it is possible to easily take image information of the detection target C reflected on the half mirror 23 by the display control unit 19 setting the light emission timing Y of the content display unit 24 and the shutter timing X of the camera 21 to be different.

Moreover, although in the present embodiment, the half mirror 23 and the content display unit 24 are configured as different parts, an integral reflector including a reflection surface and a function of displaying the content. In this case, the image information in which the detection target C and the content have been imaged is acquired by the acquisition unit 11. However, when it is extracted by the extraction unit 16, the region in which the content has been captured may be removed by machine learning before the complement processing.

Although in the present embodiment, the half mirror is used, the present technology is not limited thereto, and for example, a beam splitter may be used.

### Application Example 1

In the above-mentioned embodiments, the application example to the automobile 1 has been described as the movable object, though not limited thereto. For example, it may be a flying object such as a drone.

In a case where the present technology is applied to a drone, it may be configured to be capable of detecting a detection target, e.g., a structure such as a building or a living body such as a bird on the basis of the detection unit 13 during flight and sending a flight control signal of the drone when the detection target becomes equal to or smaller than a certain distance according to the distance measurement unit 15. The control signal can control the drone to fly while avoiding the detection target and can measure a distance between goods to a goods destination (e.g., entrance) and place the goods with no shocks when the drone delivers the goods.

In the above-mentioned embodiments, the application examples to the automobile and the drone have been described, though not limited thereto. The present technology can also be employed for objects including other movable objects, people, utility poles, and the like.

It should be noted that the present technology can also take the following configurations.
(1) An image processing apparatus, including:
   an acquisition unit that acquires a captured image including a detection target and a reflector reflecting the detection target, the captured image being captured by an imaging unit; and
   a control unit that calculates information related to a position of the detection target with respect to the imaging unit on the basis of at least one of first image information that is image information of a first image region including the detection target in the captured image or second image information that is image information of a second image region including the reflector in the captured image.
(2) The image processing apparatus according to (1), in which
   the control unit extracts a preset first particular region of the first image region and a second particular region of the second image region, the second particular region corresponding to a reflected image in the first particular region.
(3) The control apparatus according to (2), in which
   the first image information is image information of a preset first particular region of the first image region, and
   the second image information is image information of a second particular region of the second image region, the second particular region corresponding to a reflected image in the first particular region.
(4) The control apparatus according to any one of (1) to (3), in which
   the information related to the position of the detection target is a relative distance of the detection target with respect to the imaging unit.
(5) The control apparatus according to (1), in which
   the control unit determines whether or not a first pixel region corresponding to a particular pattern preset is present in at least a part of the first image information and detects dirt on a light-receiving unit of the imaging unit on the basis of a result of the determination.
(6) The control apparatus according to (5), in which
   in a case where the control unit detects dirt on the light-receiving unit, the control unit extracts a second pixel region of the second image information and generates, on the basis of pixel information of the second pixel region, a display image in which the first pixel region is complemented with the pixel information of the second pixel region, the second pixel region corresponding to a reflected image in the first pixel region.
(7) The control apparatus according to (5) or (6), in which
   in a case where the control unit detects dirt on the light-receiving unit, the control unit calculates the information related to the position of the detection target with respect to the imaging unit on the basis of the second image information.
(8) An image processing method, including:
   acquiring a captured image including a detection target and a reflector reflecting the detection target, the captured image being captured by an imaging unit; and
   calculating information related to a position of the detection target with respect to the imaging unit on the basis of at least one of first image information that is image information of a first image region including the detection target in the captured image or second image information that is image information of a second image region including the reflector in the captured image.
(9) An image processing system, including:
   an imaging unit;
   a reflector; and
   an image processing apparatus including
      an acquisition unit that acquires a captured image including a detection target and the reflector reflecting the detection target, which are imaged by the imaging unit, and
      a control unit that calculates information related to a position of the detection target with respect to the imaging unit on the basis of at least one of first image information that is image information of a first image region including the detection target in the captured image or second image information that is image information of a second image region including the reflector in the captured image.
(10) The image display system according to (9), in which
   the reflector includes a content display unit that displays preset content.
(11) The image display system according to (10), in which
   the control unit causes the content displayed by the content display unit to be periodically displayed to blink for a non-exposure period of the imaging unit.
(12) The image display system according to (10) or (11), in which
   the reflector is an optical element that causes detection target light of the detection target to be reflected to a light-receiving unit of the imaging unit and causes content light of the content display unit to pass through the optical element.
(13) The image display system according to any one of (10) to (12), in which
   the content includes a still image, a moving image, color information, or text information.
(14) The image display system according to any one of (9) to (13), in which
   the imaging unit is a vehicle-mounted camera that images at least a part of a periphery of a vehicle body, and
   the reflector is provided below the imaging unit.

### REFERENCE SIGNS LIST

1 automobile
10 image processing apparatus
11 acquisition unit
12 pre-processing unit
13 detection unit
14 dirt detection unit
distance measurement unit
16 extraction unit
17 complement unit
18 storage unit
20 camera unit
21 camera
22 mirror
30 display unit
100 image processing system
G1 first image region
G2 second image region
G3 display image

1. An image processing apparatus, comprising:
an acquisition unit that acquires a captured image including a detection target and a reflector reflecting the detection target, the captured image being captured by an imaging unit; and
a control unit that calculates information related to a position of the detection target with respect to the imaging unit on a basis of at least one of first image information that is image information of a first image region including the detection target in the captured image or second image information that is image information of a second image region including the reflector in the captured image.

2. The image processing apparatus according to claim 1, wherein
the control unit extracts a preset first particular region of the first image region and a second particular region of the second image region, the second particular region corresponding to a reflected image in the first particular region.

3. The image processing apparatus according to claim 2, wherein
the first image information is image information of a preset first particular region of the first image region, and the second image information is image information of a second particular region of the second image region, the second particular region corresponding to a reflected image in the first particular region.

4. The image processing apparatus according to claim 3, wherein
the information related to the position of the detection target is a relative distance of the detection target with respect to the imaging unit.

5. The image processing apparatus according to claim 1, wherein
the control unit determines whether or not a first pixel region corresponding to a particular pattern preset is present in at least a part of the first image information and detects dirt on a light-receiving unit of the imaging unit on a basis of a result of the determination.

6. The image processing apparatus according to claim 5, wherein
in a case where the control unit detects dirt on the light-receiving unit, the control unit extracts a second pixel region of the second image information and generates, on a basis of pixel information of the second pixel region, a display image in which the first pixel region is complemented with the pixel information of the second pixel region, the second pixel region corresponding to a reflected image in the first pixel region.

7. The image processing apparatus according to claim 5, wherein
in a case where the control unit detects dirt on the light-receiving unit, the control unit calculates the information related to the position of the detection target with respect to the imaging unit on a basis of the second image information.

8. An image processing method, comprising:
acquiring a captured image including a detection target and a reflector reflecting the detection target, the captured image being captured by an imaging unit; and
calculating information related to a position of the detection target with respect to the imaging unit on a basis of at least one of first image information that is image information of a first image region including the detection target in the captured image or second image information that is image information of a second image region including the reflector in the captured image.

9. An image processing system, comprising:
an imaging unit;
a reflector; and
an image processing apparatus including
an acquisition unit that acquires a captured image including a detection target and the reflector reflecting the detection target, which are imaged by the imaging unit, and
a control unit that calculates information related to a position of the detection target with respect to the imaging unit on a basis of at least one of first image information that is image information of a first image region including the detection target in the captured image or second image information that is image information of a second image region including the reflector in the captured image.

10. The image processing system according to claim 9, wherein
the reflector includes a content display unit that displays preset content.

11. The image processing system according to claim 10, wherein
the control unit causes the content displayed by the content display unit to be periodically displayed to blink for a non-exposure period of the imaging unit.

12. The image processing system according to claim 10, wherein
the reflector is an optical element that causes detection target light of the detection target to be reflected to a light-receiving unit of the imaging unit and causes content light of the content display unit to pass through the optical element.

13. The image processing system according to claim 10, wherein
the content includes a still image, a moving image, color information, or text information.

14. The image processing system according to claim 9, wherein
the imaging unit is a vehicle-mounted camera that images at least a part of a periphery of a vehicle body, and
the reflector is provided below the imaging unit.
